(19) United States
(12) Patent Application Publication
(10) Pub. No.: US 2012/0050819 A1
(43) Pub. Date: Mar. 1, 2012

(54) Approach For Processing Scanned Document Data

(76) Inventor: Jiang Hong, San Jose, CA (US)

(21) Appl. No.: 12/871,528

(22) Filed: Aug. 30, 2010

(51) Int. Cl. H04N 1/04

(52) U.S. Cl. 358/443

(57) ABSTRACT

An approach for processing scanned document data includes a document processing service processing scanned document data and generating text data that represents text contained in one or more printed documents. The document processing service identifies, in the text data, contact data for a recipient and uses the contact data to automatically transmit the scanned document data and/or the text data to the recipient. The contact information may be included with the text data and a confirmation may also be generated and transmitted. The document processing device may also store the text data and later retrieve and transmit the text data to a specified recipient in response to a request. The document processing service may also transmit the contact data to the scanning device so that the scanning device may make the contact data available to a user for subsequent scan jobs, for example, in an address book or contact list.

### FIELD OF THE INVENTION

This invention relates generally to scanning technology, and more specifically, to an approach for processing scanned document data.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Many individuals and business organizations are scanning an increased number of printed documents. Maintaining documents in electronic form requires less space and allows documents to be accessed by multiple users, without having to make additional printed copies. One of the issues with scanning documents is the difficulty of distributing the scanned document data to intended recipients. Distribution of scanned document data may be performed at a scanning device where the printed document is first scanned. Some scanning devices allow a user to specify a destination for the scanned document data, for example by selecting a location or recipient from an address book or contact list. The scanning device then transmits the scanned document data to the selected location or recipient.

Distribution of scanned document data may also be performed from another location. For example, a user may scan a printed document and select their name as the recipient. The scanning device transmits the scanned document data to the user, for example, by sending the scanned document data as an email attachment to the user's personal computer. The user then uses their email client to forward the scanned document data to one or more other recipients. Both of these approaches require multiple steps and can be cumbersome when contact information for the intended recipient is not already stored in either the scanning device or the user's email client, because the user has to manually enter the recipient's contact information, for example by typing an email address of the recipient. Based on the foregoing, there is a need for an approach for better processing scanned document data.

### SUMMARY

An approach is provided for processing scanned document data. A document processing service receives, from a scanning device over a network, scanned document data that represents one or more printed documents. The document processing service processes the scanned document data and generates text data that represents text contained in the one or more printed documents. The document processing service identifies, in the text data, contact data for a recipient and uses the contact data to transmit the scanned document data and/or the text data to the recipient. For example, the contact data may include an email address printed on a business card of the recipient and the document processing service generates and transmits to the email address an email that includes the scanned document data and/or the text data.

The document processing service may include the contact information with the text data and may also generate and transmit a confirmation that the text information was provided to the recipient. The document processing device may also store the text data and later retrieve and transmit the text data to a specified recipient in response to a request. The document processing service may also transmit the contact data to the scanning device so that the scanning device may make the contact data available to a user for subsequent scan jobs, for example, in an address book or contact list. The approach allows a user to quickly and easily disseminate scanned document data to multiple users over a network without having to manually enter contact information into a scanning device or email client.

According to one aspect of the invention, a computer-implemented method for processing scanned document data includes a document processing service that executes on a network device receiving, from a scanning device over a network, scanned document data that represents one or more printed documents. The document processing service processes the scanned document data and generates text data that represents text contained in the one or more printed documents. The document processing service processes the text data to identify in the text data contact data for a recipient and uses the contact data to transmit to the recipient one or more of the scanned document data and the text data.

### BRIEF DESCRIPTION OF THE DRAWINGS

In the figures of the accompanying drawings like reference numerals refer to similar elements.

FIG. 1 is a block diagram that depicts an example architecture for processing scanned document data.

FIG. 2 depicts an example operation panel of a scanning device.

FIG. 3 is a block diagram that depicts an example architecture of a mobile wireless device.

FIG. 4 is a message ladder diagram that depicts an example message exchange between the elements of FIG. 1 during the processing of scanned document data as described herein.

FIG. 5 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. SCANNED DOCUMENT DATA PROCESSING ARCHITECTURE

III. PROCESSING SCANNED DOCUMENT DATA

IV. IMPLEMENTATION MECHANISMS

### I. OVERVIEW

An approach is provided for processing scanned document data. A document processing service receives, from a scanning device over a network, scanned document data that represents one or more printed documents. The document processing service processes the scanned document data and generates text data that represents text contained in the one or more printed documents. The document processing service identifies, in the text data, contact data for a recipient and uses the contact data to transmit the scanned document data and/or the text data to the recipient. For example, the contact data may include an email address printed on a business card of the recipient and the document processing service generates and transmits to the email address an email that includes the scanned document data and/or the text data. The document processing service may include the contact information with the text data and may also generate and transmit a confirmation that the text information was provided to the recipient. The document processing device may also store the text data and later retrieve and transmit the text data to a specified recipient in response to a request. The document processing service may also transmit the contact data to the scanning device so that the scanning device may make the contact data available to a user for subsequent scan jobs, for example, in an address book or contact list. The approach allows a user to quickly and easily disseminate scanned document data and/or text data to multiple users over a network without having to manually enter contact information into a scanning device or email client.

### II. SCANNED DOCUMENT DATA PROCESSING ARCHITECTURE

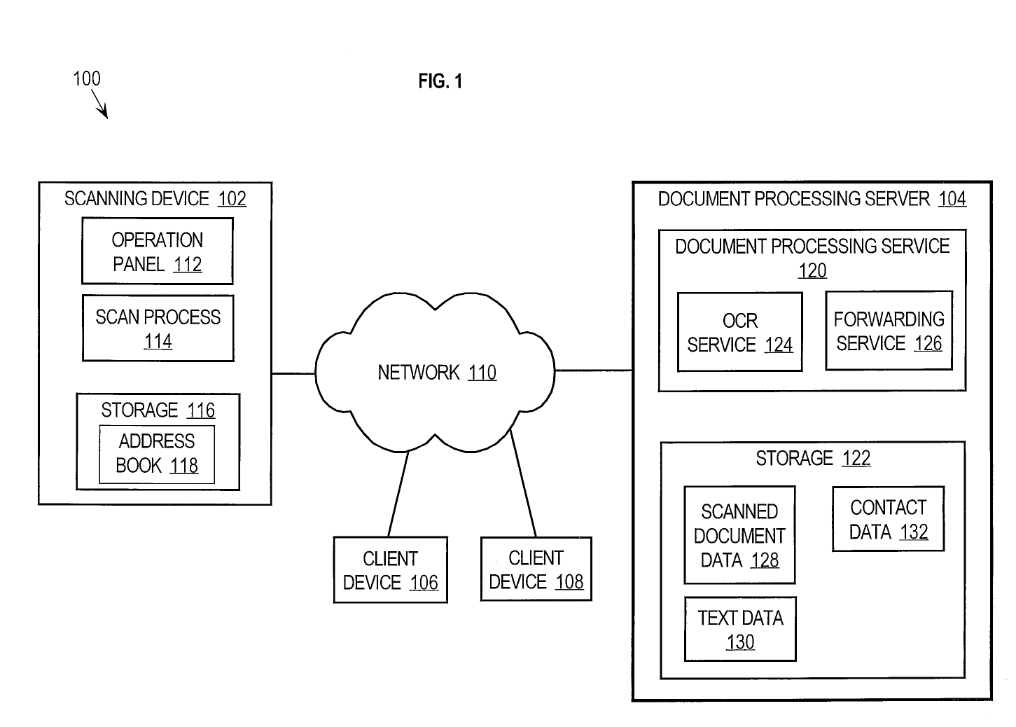

FIG. 1 is a block diagram that depicts an example architecture for processing scanned document data. Architecture 100 includes a scanning device 102, a document processing server 104 and client devices 106, 108, communicatively coupled via a network 110. Network 110 may be implemented by any medium or mechanism that provides for the exchange of data between the elements of FIG. 1. Examples of network 110 include, without limitation, a network such as a Local Area Network (LAN), Wide Area Network (WAN), Ethernet or the Internet, or one or more terrestrial, satellite or wireless links.

Scanning device 102 is a device that includes the capability to scan one or more printed documents and generate scanned document data that represents the one or more printed documents. The scanned document data may be in a variety of formats, depending upon a particular implementation. One example format is the portable document format (PDF) by Adobe Systems, Inc. Scanning device 102 may also include a capability to convert scanned document data from a non-text format, such as PDF, to a text-based format, using for example, optical character recognition (OCR). Scanning device 102 may also include the capability to transmit the scanned document data to another location or device, for example, to a computer connected to the scanning device 102 or over a network to a network device. Examples of scanning device 102 include, without limitation, a scanner and a multi-function peripheral that includes one or more functions in addition to scanning, such as printing, copying, faxing, etc.

Scanning device 102 includes an operation panel 112, a scan process 114 and storage 116. The operation panel 112 is configured to display information to a user and to accept user input. The particular implementation of the operation panel 112 may vary depending upon a particular implementation. For example, the operation panel 112 may include a screen on which a graphical user interface (GUI) is displayed. In addition, the screen may be a touch screen that allows a user to select icons and GUI objects on the GUI. The GUI may be updated to reflect changes in the functionality offered by the scanning device 102. The operation panel 112 may also include control buttons and a numeric keypad for receiving user input.

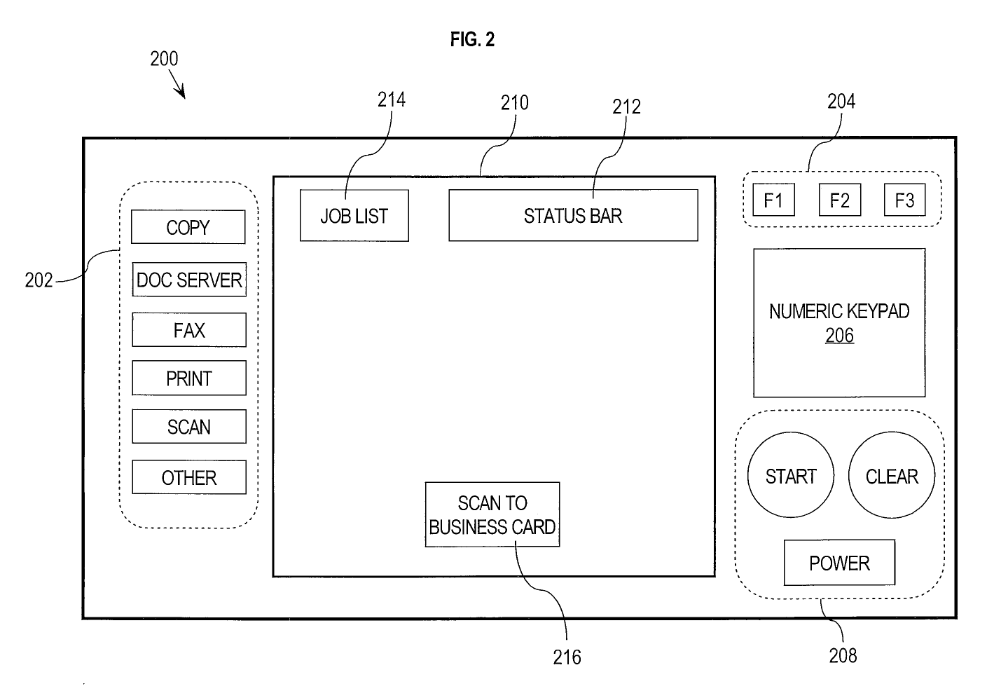

FIG. 2 depicts an example operation panel 200 of the scanning device 102. Operation panel 200 includes a set of user interface controls 202 for activating functions of the scanning device 102. The functions depicted in FIG. 2 include copy, connect to a document server, fax, print, copy and other functions. These functions are provided as examples of typical functions that may be implemented on a scanning device that is an MFP, but the functions implemented on any particular scanning device may vary depending upon the implementation. Operation panel 200 also includes a set of function buttons 204 that may be assigned to various functions provided on scanning device 102. Operation panel 200 also includes a numeric keypad 206 and a set of user controls 208 for toggling the power, starting a function and clearing the current function. These are examples of the user controls that are typically included on a scanning device and different more or few user controls may be provided, depending upon a particular implementation.

Operation panel 200 also includes a GUI 210 for displaying information and receiving user input. GUI 210 may be a touch screen that is capable of detecting user selection of icons and GUI objects displayed on GUI 210. In the present example, GUI 210 includes a status bar GUI object 212 that displays status information, such as the status of the scanning device 102 or the status of one or more scan jobs. GUI 210 also includes a job list GUI object 214 which, when selected, displays a list of jobs associated with the scanning device 102, for example, scan jobs that have been processed and/or scan jobs that are currently being processed. GUI 210 also includes a scan to business card GUI object 216 that initiates the processing scanned document data, as described in more detail hereinafter. GUI 210 may include any number of other GUI objects depending upon a particular implementation, and the GUI objects depicted in FIG. 2 are provided as non-limiting examples.

Scan process 114 is configured to cause one or more printed documents to be scanned by scanning device 102 and generate scanned document data that represents the one or more printed documents. Scan process 114 may be initiated, for example, in response to a user selection of the start user control 208.

Storage 116 may be any combination of volatile or non-volatile storage for storing data used by scanning device 102. For example, the storage 116 may be random access memory (RAM), one or more disks, or any combination of RAM and one or more disks for storing scanned document data. As depicted in FIG. 1, storage 116 may store an address book 118 or contact data that is used by scanning device 102, for example, to obtain destination addresses for transmitting scanned document data. Scanning device 102 may include other modules and processes that are not depicted in FIG. 1 for purposes of brevity.

Document processing server 104 hosts a document processing service 120 for processing scanned document data as described in more detail hereinafter. Although embodiments of the invention are described herein in the context of the document processing server 104 being a network server, the invention is not limited to this context and the document processing service 120 may be implemented on other types of network device. Document processing service 120 includes an OCR service 124 for converting scanned document data in non-text format, for example PDF, into text-based format. Document processing service 120 also includes a forwarding service 126 for transmitting scanned document data in text format to one or more recipients. OCR service 124 and forwarding service 126 are depicted in FIG. 1 as being part of document processing service 120 for purposes of explanation, but OCR service 124 and forwarding service 126 may be implemented separate from document processing service 120.

Storage 122 may be implemented as any type of volatile or non-volatile storage for storing data used by document processing server 104. For example, storage 122 may be random access memory (RAM), one or more disks, or any combination of RAM and one or more disks for storing scanned document data. As depicted in FIG. 1, storage 122 may store scanned document data 128 received by and/or processed by the document processing service 120, text data 130 generated by OCR service 124 and contact data 132 extracted by document processing service 120 from the text data generated by OCR service 124, as described in more detail hereinafter. Document processing server 104 may include other modules and processes that are not depicted in FIG. 1 for purposes of brevity.

Client devices 106, 108 receive scanned document data and/or text data from document processing service 120, as described in more detail hereinafter. Client devices 106, 108 may be implemented as any type of client device. Examples of client devices 106, 108 include, without limitation, personal or laptop computers, workstations, cellular telephony devices such as cell phones, personal digital assistants (PDAs), etc.

### III. PROCESSING SCANNED DOCUMENT DATA

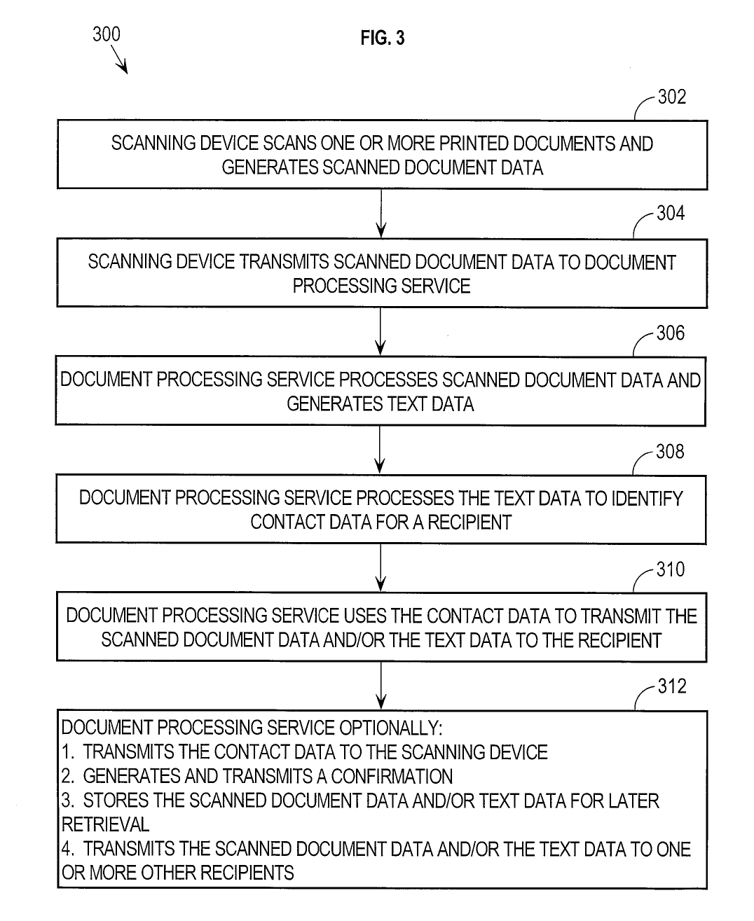

FIG. 3 is a flow diagram 300 that depicts an approach for processed scanned document data, according to one embodiment of the invention. In step 302, a scanning device scans one or more printed documents and generates scanned document data. For example, a user may place into a feeder of scanning device 102 one or more printed documents and select the scan user interface control 202 to initiate scanning. According to one embodiment of the invention, contact information is also scanned with the one or more printed documents. For example, a business card may be included with the printed document. As another example, a contact sheet containing contact information for a recipient may be scanned with the one or more printed documents.

In step 304, the scanning device transmits the scanned document data to a document processing service. For example, scanning device 102 may transmit the scanned document data to a particular port on document processing server 104 that corresponds to the document processing service 120.

In step 306, the document processing service processes the scanned document data and generates text data. For example, document processing service 120 may use OCR service 124 to processed the received scanned document data and generate text data 130, that may be stored on storage 122.

In step 308, the document processing service processes the text data 130 to identify contact data for a recipient. For example, the document processing service 120 may identify an email address for a recipient contained in the text data 130. This may include searching the text data 130 for text strings and/or symbols that correspond to an email address, for example “X@Y.com,” where X and Y are text strings. A search may also be performed for strings that correspond to known email addresses or known domains. For example, a search may be performed for email domains of specified business organizations with whom a recipient is likely to be associated. An administrator may configure document processing service 120 with the text strings or email domains to be searched. According to another embodiment of the invention, searching for contact information may include searching for a business card template contained in the text data 130, i.e., data that is normally included together on a business card. For example, the document processing service 120 may search for a grouping of text strings that correspond to an organization name, a contact name, an email address that corresponds to the contact name and a telephone and/or facsimile number. When such a grouping is identified, indicating the presence of business card information, the contact information, e.g., the email address is extracted. In some situations, the printed documents that are scanned may contain email addresses. For example, it is not uncommon for authors of papers to include their contact information, including an email address in the papers. To avoid inadvertently retrieving contact information from the printed documents that were scanned, the search for contact data may be limited to certain portions of the scanned document data 128. For example, the search may be limited to the first or last page of the scanned document data 128, under the assumption that the user added the contact information, e.g., business card or contact sheet, to either the beginning or the end of the scan job. The identified contact data 132 may be stored on storage 122.

In step 310, the document processing service uses the identified contact data to transmit the scanned document data and/or the text data 130 to the recipient. For example, the document processing service 120 may generate an email addressed to the email address identified in the text data 130. The text data 130 may be contained in the email or attached to the email. The document processing service 120 invokes the forwarding service 126 to transmit the email to the recipient.

In step 312, one or more optional steps may be performed. For example, the contact data 132 may be transmitted to the scanning device and used by the scanning device for future scanning functions. For example, the document processing service 120 may transmit the contact data 132 to the scanning device 102 so that the scanning device 102 may add the contact information to the address book 118 or a contact list. The contact data 132 may be transmitted with the text data 130 or separate from the text data 130, depending upon a particular implementation. For example, document processing service 120 may generate and transmit to scanning device 102 a “add contact” message that includes the contact information of the recipient. The scanning device 102 adds the contact information to the address book 118 or a contact list. The scanning device 102 may notify a user that the new contact information has been stored. The scanning device 102 may also update GUI 210 to include the contact information for future scans. The scanning device 102 may also include logic to detect whether the contact information is currently included in the address book 118 or contact list and if so, query the user to either override the existing information or to cancel the add operation.

The contact data 132 may also be maintained on the document processing server 104 in a manner so that it can be accessed by users and administrators. The document processing service 120 and/or the document processing server 104 may provide an interface to allow access to the contact data 132 by other devices and services. For example, a user may retrieve the contact data 132 from the document processing server 104 and update a contact list on a PDA or a personal computer. The contact data 132 may also be used by other services, for example a service that generates a Web-based GUI for the scanning device 102, so that the next time the GUI is pushed to the scanning device, it will include the most recent contact data 132.

Another optional step includes the document processing service generating and transmitting a confirmation that indicates that the operation has been completed. For example, document processing service 120 may generate and transmit a confirmation indicating that particular scanned document data 128 and/or text data 130 was transmitted to a particular recipient. The confirmation may be sent to, for example, the user that performed the scan at the scanning device 102. In this situation, the scanning device 102 may include in the scanned document data, data that identifies the user who requested the scan of the one or more printed documents. The document processing service 120 may be configured to locate in the text data 130 specified text or symbols that identify where the confirmation is to be sent. For example, scan process 114 may be configured to add to the scanned document data a text string “Send Confirmation To: XXX” when the scan to business card GUI object 216 is selected, where XXX is an email address that corresponds to the user who initiated the scan to business card operation. The document processing service 120 is configured to search the text data 130 for the text string “Send Confirmation To:” and extract and use the address contained in XXX for the confirmation. The confirmation may also be sent to one or more recipients, depending upon a particular implementation. For example, instead of or in addition to sending a confirmation to an email address included in the scanned document data, document processing device 120 may be configured to send the confirmation to a specified address, for example of a particular user or administrator.

A further optional step includes the document processing service storing the scanned document data and/or the text data for later retrieval. For example, document processing service 120 may store in storage 122 scanned document data 128 received by and/or processed by the document processing service 120. The document processing service 120 may also store the text data 130 in storage 122 for later retrieval. The scanned document data 128 and the text data 130 may be retrieved, for example by a user via scanning device 102 or a user or administrator via client device 106, 108.

As a further optional step, the scanned document data and/or text data may be transmitted to one or more other recipients, in addition to the contact information of the recipient extracted from the scanned document data, as previously described herein. The other recipients may be specified in the scanned document data. Alternatively, document processing service 120 may be configured with the contact information of the other recipients.

The approach described herein for processing scanned document data provides a very beneficial workflow for users. The approach allows a user to include with one or more printed documents to be scanned, contact information, such as a business card or a contact sheet, so that the scanned document data includes the scanned contact information. The document processing service converts the scanned document data into a text-based format and extracts the contact information. The document processing service then automatically transmits the scanned document data, the text data, or both the scanned document data and the text data to the recipient, without the user having to manually enter the contact information of the recipient. In addition, the contact information may be provided back to the scanning device and added to an address book or contact list so that future scan jobs may be directed to the recipient. This may include the scanning device automatically updating its GUI with a GUI object that corresponds to the recipient.

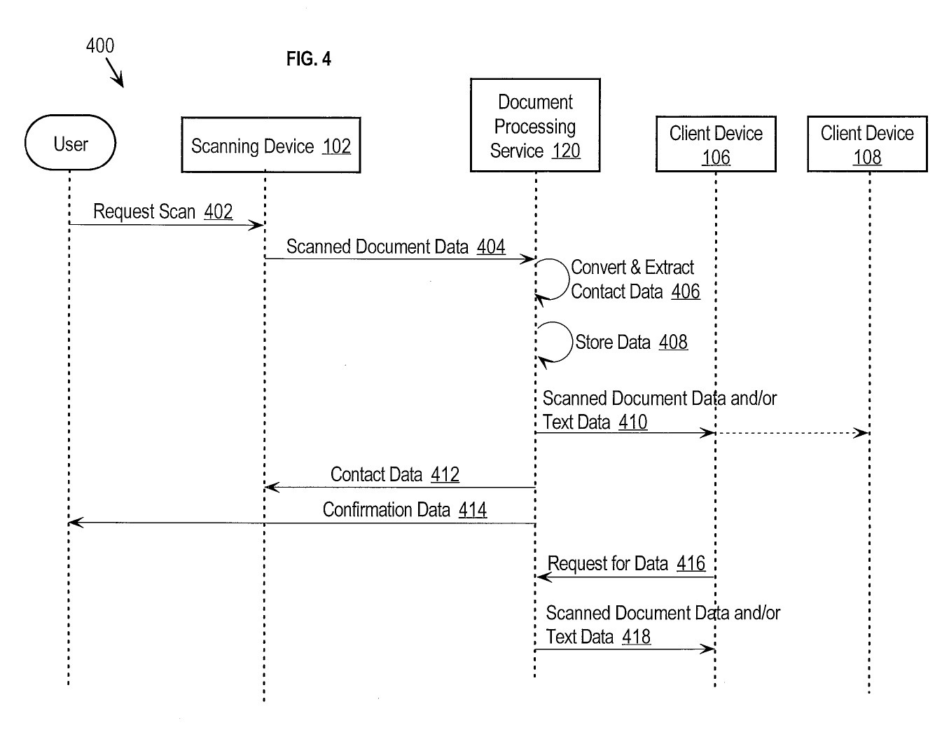

FIG. 4 is a message ladder diagram 400 that depicts an example message exchange between the elements of FIG. 1 during the processing of scanned document data as described herein. In step 402, a user requests that one or more printed documents be scanned. For example, a user may place one or more printed documents into an input bin of scanning device 102 and select the scan to business card GUI object 216. The user may include contact information for an intended recipient of the scanned document data. For example, the user may include in the one or more printed documents a business card or contact sheet for the recipient. In response to the user's request to scan, the scanning device 102 scans the one or more printed documents and generates scanned document data. The scanned document data represents the one or more printed documents and also includes the contact information for the recipient.

In step 404, the scanning device transmits the scanned document data to the document processing service 120. In step 406, the document processing service 120 processes the scanned document data and generates text data that represents text contained in the one or more printed documents. The text data also includes the contact information for the recipient. The document processing service 120 also extracts the contact information from the text data 130, as previously described herein. In step 408, the document processing service 120 optionally stores the scanned document data 128 and/or the text data 130 on storage 122. In step 410, the document processing service 120 transmits the scanned document data 128 and/or the text data 130 to the recipient specified in the contact information. For example, the document processing service 120 may transmit the scanned document data 128 and/or the text data 130 to a client device 106. The scanned document data 128 and/or the text data 130 may be provided to multiple recipients. For example, the document processing service 120 may also transmit the scanned document data 128 and/or the text data 130 to a client device 108.

In step 412, the document processing service 120 optionally transmits the contact data to the scanning device 102. As previously described herein, the scanning device 102 may update the address book 118 or a contact list with the contact information received from document processing service 120. The scanning device 102 may notify a user that the new contact information has been stored. The scanning device 102 may also update GUI 210 to include the contact information for future scans. The scanning device 102 may also include logic to detect whether the contact information is currently included in the address book 118 or contact list and if so, query the user to either override the existing information or to cancel the add operation. As previously described herein, the contact data 132 may be maintained on the document processing server 104 and made available to other devices and services.

In step 414, the document processing service 120 optionally generates and transmits confirmation data that indicates that the scanned document data 128 and/or the text data 130 was provided to the recipient. In the present example, the confirmation data is transmitted to the user that initiated the scan of the one or more printed documents.

In step 416, the document processing service 120 may receive a request for scanned document data 128 and/or text data 130 stored on the document processing server 104. In step 418, in response to the request, the document processing service 120 provides the requested scanned document data 128 and/or the text data 130 to a requestor, for example, client device 106. For example, document processing service 120 may provide an interface that allows users to retrieve scanned document data 128 and/or the text data 130 stored on document processing server 104.

### IV. IMPLEMENTATION MECHANISMS

Although the flow diagrams of the present application depict a particular set of steps in a particular order, other implementations may use fewer or more steps, in the same or different order, than those depicted in the figures.

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

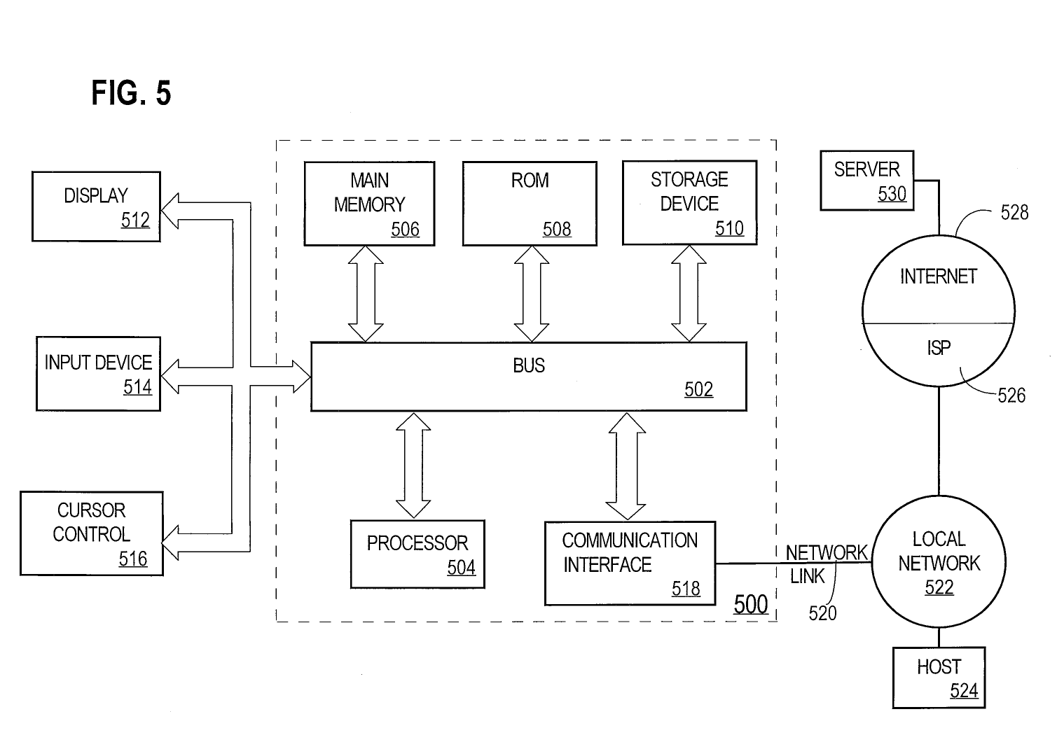

FIG. 5 is a block diagram that depicts an example computer system 500 upon which embodiments of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic or computer software which, in combination with the computer system, causes or programs computer system 500 to be a special-purpose machine. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operation in a specific manner. In an embodiment implemented using computer system 500, various computer-readable media are involved, for example, in providing instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method for processing scanned document data, the computer-implemented method comprising:
a document processing service executing on a network device and receiving, from a scanning device over a network, scanned document data that represents one or more printed documents;
the document processing service processing the scanned document data and generating text data that represents text contained in the one or more printed documents;
the document processing service processing the text data to identify in the text data contact data for a recipient; and
the document processing service using the contact data to transmit to the recipient one or more of the scanned document data and the text data.

2. The computer-implemented method as recited in claim 1, wherein:
the scanned document data includes a scanned business card,
the contact data includes an email address for the recipient printed on the business card, and
the document processing service using the contact data to transmit to the recipient one or more of the scanned document data and the text data includes the document processing service generating and transmitting to the email address an email that includes one or more of the scanned document data and the text data.

3. The computer-implemented method as recited in claim 1, wherein:
the scanned document data is in portable document format, and
the document processing service processing the scanned document data includes the document processing service performing optical character recognition on the scanned document data.

4. The computer-implemented method as recited in claim 1, further comprising the document processing service generating and transmitting to a second recipient a confirmation that indicates that one or more of the scanned document data and the text data were transmitted to the recipient.

5. The computer-implemented method as recited in claim 1, wherein the document processing service processing the text data to identify in the text data contact data for a recipient includes identifying one or more text strings contained in the text data that match one or more specified text strings.

6. The computer-implemented method as recited in claim 1, further comprising:
the document processing service storing one or more of the scanned document data and the text data, and
in response to receiving a request for the text data, the document processing service retrieving and transmitting the text data to a specified recipient one or more of the scanned document data and the text data.

7. The computer-implemented method as recited in claim 1, further comprising the document processing service transmitting the contact data to the scanning device.

8. A computer-readable medium for processing scanned document data, the computer-readable medium storing instructions which, when processed by one or more processors, cause:
a document processing service executing on a network device and receiving, from a scanning device over a network, scanned document data that represents one or more printed documents;
the document processing service processing the scanned document data and generating text data that represents text contained in the one or more printed documents;
the document processing service processing the text data to identify in the text data contact data for a recipient; and
the document processing service using the contact data to transmit to the recipient one or more of the scanned document data and the text data.

9. The computer-readable medium as recited in claim 8, wherein:
the scanned document data includes a scanned business card,
the contact data includes an email address for the recipient printed on the business card, and
the document processing service using the contact data to transmit to the recipient one or more of the scanned document data and the text data includes the document processing service generating and transmitting to the email address an email that includes one or more of the scanned document data and the text data.

10. The computer-readable medium as recited in claim 8, wherein:
the scanned document data is in portable document format, and
the document processing service processing the scanned document data includes the document processing service performing optical character recognition on the scanned document data.

11. The computer-readable medium as recited in claim 8, further comprising additional instructions which, when processed by the one or more processors, causes the document processing service generating and transmitting to a second recipient a confirmation that indicates that one or more of the scanned document data and the text data were transmitted to the recipient.

12. The computer-readable medium as recited in claim 8, wherein the document processing service processing the text data to identify in the text data contact data for a recipient includes identifying one or more text strings contained in the text data that match one or more specified text strings.

13. The computer-readable medium as recited in claim 8, further comprising additional instructions which, when processed by the one or more processors, causes:
the document processing service storing one or more of the scanned document data and the text data, and
in response to receiving a request for the text data, the document processing service retrieving and transmitting the text data to a specified recipient one or more of the scanned document data and the text data.

14. The computer-readable medium as recited in claim 8, further comprising additional instructions which, when processed by the one or more processors, causes the document processing service transmitting the contact data to the scanning device.

15. An apparatus for processing scanned document data, the apparatus comprising:
one or more processors; and
a memory storing instructions which, when processed by the one or more processors, cause:
a document processing service executing on a network device and receiving, from a scanning device over a network, scanned document data that represents one or more printed documents;
the document processing service processing the scanned document data and generating text data that represents text contained in the one or more printed documents;
the document processing service processing the text data to identify in the text data contact data for a recipient; and
the document processing service using the contact data to transmit to the recipient one or more of the scanned document data and the text data.

16. The apparatus as recited in claim 15, wherein:
the scanned document data includes a scanned business card,
the contact data includes an email address for the recipient printed on the business card, and
the document processing service using the contact data to transmit to the recipient one or more of the scanned document data and the text data includes the document processing service generating and transmitting to the email address an email that includes one or more of the scanned document data and the text data.

17. The apparatus as recited in claim 15, wherein:
the scanned document data is in portable document format, and
the document processing service processing the scanned document data includes the document processing service performing optical character recognition on the scanned document data.

18. The apparatus as recited in claim 15, wherein the memory stores additional instructions which, when processed by the one or more processors, causes the document processing service generating and transmitting to a second recipient a confirmation that indicates that one or more of the scanned document data and the text data were transmitted to the recipient.

19. The apparatus as recited in claim 15, wherein the document processing service processing the text data to identify in the text data contact data for a recipient includes identifying one or more text strings contained in the text data that match one or more specified text strings.

20. The apparatus as recited in claim 15, wherein the memory stores additional instructions which, when processed by the one or more processors, causes the document processing service transmitting the contact data to the scanning device.
